(19) United States
(12) Patent Application Publication
(10) Pub. No.: US 2026/0111174 A1
(43) Pub. Date: Apr. 23, 2026

(54) TENSOR PROCESSING CIRCUITRY

(71) Applicant: Arm Limited, Cambridge (GB)

(72) Inventors: John Wakefield BROTHERS, III, Calistoga, CA (US); Jens OLSON, San Jose, CA (US)

(21) Appl. No.: 18/919,178

(22) Filed: Oct. 17, 2024

(51) Int. Cl. G06F 7/544; G06F 5/01; G06F 7/485

(52) U.S. Cl. CPC G06F 7/5443; G06F 5/012; G06F 7/485

(57) ABSTRACT

A tensor processing circuitry comprising a plurality of dot product units and normalization circuitry. Each dot product unit comprises first-stage circuitry and second-stage circuitry. The first-stage circuitry is configured to receive a plurality of input values and perform at least a multiply-accumulate operation on pairs of the plurality of input values, the multiply-accumulate operation produces an output value in a unnormalized floating-point format. The second stage circuitry is configured to receive a plurality of the unnormalized floating-point output values from the first stage circuitry and perform an accumulate operation on each of the received unnormalized floating-point output values to generate an unnormalized result. The unnormalized result of the accumulate operation is then output to the normalization circuitry which normalizes the unnormalized results.

### BACKGROUND OF THE INVENTION

### Field of the Invention

The present invention relates to tensor processing circuitry and an associated method for the efficient processing of tensor data using unnormalized intermediaries.

### Description of the Related Technology

Certain data processing techniques, such as neural network processing a graphics processing, involve the processing and generation of considerable amounts of data using operations.

### SUMMARY

According to a first aspect of the present invention, there is provided tensor processing circuitry comprising a plurality of dot product units; and normalization circuitry, wherein each dot product unit comprises first-stage circuitry and second-stage circuitry, the first-stage circuitry configured to receive a plurality of input values; and perform at least a multiply-accumulate operation on pairs of the plurality of input values, the multiply-accumulate operation producing an output value in a unnormalized floating-point format; and the second stage circuitry configured to receive a plurality of the unnormalized floating-point output values from the first stage circuitry; perform, by an accumulator of the second stage circuitry, an accumulate operation on each of the received unnormalized floating-point output values to generate an unnormalized; result; and output the denormalized result of the accumulate operation to the normalization circuitry; and wherein the normalization circuitry is configured to receive unnormalized results from the plurality of dot product units and normalize the unnormalized results. This allows the hardware required for the normalization of the outputs of a multiply-accumulate (‘MAC’) operation to be amortized across multiple dot product units, along with reducing the processing costs associated with such normalization, by using a unnormalized accumulator, and storing the unnormalized outputs in a unnormalized format.

Optionally, the second-stage circuitry further comprises overflow detection circuitry for detecting whether the accumulate operation will result in an overflow of the accumulator of the second stage circuitry. The overflow detection circuitry may perform at least an XOR operation on the two most significant bits of a mantissa of a currently stored unnormalized result in the accumulator of the second stage circuitry. The XOR operation may indicate that the multiply-accumulate operation may result in an overflow when the result of the XOR operation is 1; and that the multiply-accumulate operation will not result in an overflow when the result of the XOR operation is 0. This enables the detection of potential overflow resulting from an operation, and in some examples the use of minimal hardware for the efficient detection of overflows. By using an XOR, this is an efficient way of doing this by checking what the most significant bit is-if it is a 1 then overflow will occur, if 0 then no overflow. This reduces the complexity and increases the efficiency of detecting overflows.

The second stage circuitry may comprise partial normalization circuitry for partially normalizing the output of the accumulate operation when the overflow detection circuitry detects an overflow. Optionally the partial normalization circuitry comprises shift circuitry for right-shifting the currently stored unnormalized result by one. This enables the subsequent prevention of overflow by performing a quick, and efficient partial normalization without the need to perform a more costly full normalization. This means that overall efficiencies can be gained whilst minimizing hardware requirements, since full normalization is still performed separately by the normalization circuitry.

The plurality of input values may each comprise a sign, an 8-bit exponent, and an 8-bit mantissa.

The tensor processing circuitry may comprise a given number of dot product units, wherein the normalization circuitry is configured to normalize the unnormalized results from the given number of dot product units every given number of cycles. Theis enables the results from a plurality of dot product units to be normalized efficiently, such that the output of each dot product unit has been calculated prior to normalization, further increasing efficiency and reducing power requirements since unnecessary normalization is prevented and/or minimized.

Optionally, a predetermined number of pairs of input values are received, and the normalization circuitry performs the predetermined number of multiply-accumulate operations at each dot product unit each cycle. This results in increased efficiency and power reductions since the required amount of MAC operations are undertaken each cycle, minimizing the downtime of each dot product unit.

The at least one dot product unit and normalization circuitry may be configured for performing matrix multiplication and/or accumulation. The tensor processing circuitry may be part of a machine learning accelerator.

According to a second aspect of the present invention, there is provided a method performed by a convolution engine comprising at each of a plurality of dot product units of the convolution engine receiving, at a first stage of each dot product unit, a plurality of input values; performing, at a first stage of each dot product unit, at least a multiply-accumulate operation on pairs of the plurality of input values, the multiply-accumulate operation producing an output value in an unnormalized floating-point format; and performing, at a second stage of each dot product unit, an accumulate operation on each of the unnormalized floating point output values to generate a unnormalized result; and normalizing, at a normalization circuitry, at least the unnormalized results from the plurality of dot product units. This allows the hardware required for the normalization of the outputs of a multiply-accumulate (‘MAC’) operation to be amortized across multiple dot product units, along with reducing the processing costs associated with such normalization, by using an unnormalized accumulator, and storing the unnormalized outputs in an unnormalized format.

According to a third aspect of the present invention, there is provided a processing unit for handling data, the processing unit comprising tensor processing circuitry according to the first aspect, wherein the processor is configured to perform one or more convolution and/or matrix multiply operation using the tensor processing circuitry. This allows the hardware required for the normalization of the outputs of a multiply-accumulate (‘MAC’) operation to be amortized across multiple dot product units, along with reducing the processing costs associated with such normalization, by using an unnormalized accumulator, and storing the unnormalized outputs in an unnormalized format.

According to a fourth aspect of the present invention, there is provided a system comprising the tensor processing circuitry according to the first aspect, implemented in at least one packaged chip; at least one system component; and a board, wherein the at least one packaged chip and the at least one system component are assembled on the board.

According to a fifth aspect of the present invention, there is provided a chip-containing product comprising the system of the fourth aspect, wherein the system is assembled on a further board with at least one other product.

According to a sixth aspect of the present invention, there is provided a non-transitory computer-readable storage medium having stored thereon, computer-readable code for the fabrication of the tensor processing circuitry according to the first aspect.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 illustrates a schematic diagram of tensor processing circuitry according to the present disclosure;

FIG. 2 illustrates a schematic diagram of a dot-product unit for use with the tensor processing circuitry shown in FIG. 1;

FIG. 3 is a flowchart showing a method according to the present disclosure;

FIG. 4 illustrates a schematic diagram of a processor according to the present disclosure;

FIG. 5 illustrates schematically an example system for processing tensors according to the present disclosure; and

FIG. 6 illustrates a system comprising one or more packaged chips according to an example.

### DETAILED DESCRIPTION OF CERTAIN INVENTIVE EMBODIMENTS

Examples herein relate to tensor processing circuitry designed to accelerate machine learning, deep learning, and other complex mathematical operations, particularly those involving large-scale matrix computations essential for artificial intelligence (AI) and neural networks.

The increasing demand for high-performance, energy-efficient solutions in AI and machine learning applications has driven the development of dedicated tensor processing hardware. Traditional general-purpose processors, such as central processing units (CPUs) and graphics processing units (GPUs), often lack the specialized architecture required to handle the vast parallelism and dataflow inherent in tensor computations, leading to performance bottlenecks and excessive power consumption.

The examples described herein introduce improved tensor processing circuitry that optimizes the execution of tensor operations, enabling higher computational throughput and efficiency while reducing latency and power consumption. These examples address the limitations of current hardware by introducing architectural designs and techniques that streamline the processing of multi-dimensional arrays (tensors) used in machine learning algorithms, such as convolutional neural networks (CNNs) and recurrent neural networks (RNNs), by the efficient use of unnormalized floating-point intermediaries to accumulate outputs across multiple hardware components. These improvements result in significant performance gains for tensor-based computations, making the circuitry ideal for deployment in edge devices, data centers, and cloud-based AI platforms.

Tensor processing requires the efficient use and handling of different formats of numbers throughout the processing of tensors, including the efficient use of floating-point (FP). FP is a useful way of approximating real numbers using a small number of bits. The IEEE 754-2008 FP standard proposes multiple different formats for FP numbers, but three of these are binary 64 (also known as double precision, or DP), binary 32 (also known as single precision, or SP), and binary 16 (also known as half precision, or HP). The numbers 64, 32, and 16 refer to the number of bits required for each format. Floating point numbers are regularly used during neural network processing, and therefore neural engines, such as the processor 700 described below may support such floating-point formats. These floating-point numbers may be represented in a number of ways, as will be described below.

### Floating-Point (FP) Representation

FP numbers are quite similar to the “scientific notation” taught in science classes, where instead of negative two million we′d write −2.0×10⁶. The parts of this number are the sign (in this case negative), the significand (2.0), the base of the exponent (10), and the exponent (6). All of these parts have analogs in FP numbers, although there are differences, the most important of which is that the constituent parts are stored as binary numbers, and the base of the exponent is always 2.

More precisely, FP numbers consist of a sign bit, some number of biased exponent bits, and some number of fraction bits. In particular, the DP, SP and HP formats consist of the following bits (indicating their positions):

TABLE 1

| format | sign | exponent | fraction | exponent bias |
|---|---|---|---|---|
| DP [63:0] | 63 | 62:52 (11 bits) | 51:0 (52 bits) | 1023 |
| SP [31:0] | 31 | 30:23 (8 bits) | 22:0 (23 bits0 | 127 |
| HP [15:0] | 15 | 14:10 (5 bits) | 9:0 (10 bits) | 15 |

The sign is 1 for negative numbers and 0 for positive numbers. Every number, including zero, has a sign.

The exponent is biased, which means that the true exponent differs from the one stored in the number. For example, biased SP exponents are 8-bits long and range from 0 to 255. Exponents 0 and 255 are special cases, but all other exponents have bias 127, meaning that the true exponent is 127 less than the biased exponent. The smallest biased exponent is 1, which corresponds to a true exponent of −126. The maximum biased exponent is 254, which corresponds to a true exponent of 127. HP and DP exponents work the same way, with the biases indicated in the table above.

SP exponent 255 (or DP exponent 2047, or HP exponent 31) is reserved for infinities and special symbols called NaNs (not a number). Infinities (which can be positive or negative) have a zero fraction. Any number with exponent 255 and a nonzero fraction is a NaN. Infinity provides a saturation value, so it actually means something like “this computation resulted in a number that is bigger than what we can represent in this format.” NaNs are returned for operations that are not mathematically defined on the real numbers, for example division by zero or taking the square root of a negative number.

Exponent zero, in any of the formats, is reserved for subnormal numbers and zeros. A normal number represents the value:

$$- 1 sign \times 1. fraction \times {2}^{e}$$

where e is the true exponent computed from the biased exponent. The term 1.fraction is called the significand (also referred to as the mantissa), and the 1 is not stored as part of the FP number but is instead inferred from the exponent. All exponents except zero and the maximum exponent indicate a significand of the form 1.fraction. The exponent zero indicates a significand of the form 0.fraction, and a true exponent that is equal to 1-bias for the given format. Such a number is called subnormal (historically these numbers were referred to as denormal, but modern usage prefers the term subnormal). Numbers with both exponent and fraction equal to zero are zeros.

Table 2 has some example numbers in HP format. The entries are in binary, with characters added to increase readability. Notice that the subnormal entry (4th line of the table, with zero exponent) produces a different significand than the normal entry in the preceding line.

TABLE 2

| | 5-bit | 10-bit | 11-bit | |
|---|---|---|---|---|
| Sign | exponent | fraction | significand | value |
| 0 | 01111 | 00 0000 | 100 0000 | 1.0 × 2⁰ |
| | | 000 | 0000 | |
| 1 | 01110 | 10 0000 | 110 0000 | −1.1 × 2⁻¹ |
| | | 0000 | 0000 | |
| 0 | 00001 | 10 0000 | 110 0000 | 1.1 × 2⁻¹⁴ |
| | | 0000 | 0000 | |
| 0 | 00000 | 10 0000 | 010 0000 | 0.1 × 2⁻¹⁴ |
| | | 0000 | 0000 | |
| 1 | 11111 | 00 0000 | | −infinity |
| | | 0000 | | |
| 0 | 11111 | 001 1111 | | NaN |
| | | 0011 | | |

A large part of the complexity of FP implementation is due to sub-normals, therefore they are often handled by microcode or software. Some implementations handle sub-normals in hardware, speeding up these operations by a factor of 10 to 100 compared to a software or microcode implementation.

### Integers, Fixed-Point, Floating-Point

The FP way of handling signs is called sign-magnitude, and it is different from the usual way integers are stored in the computer (two's complement). In sign-magnitude representation, the positive and negative versions of the same number differ only in the sign bit. A 4-bit sign-magnitude integer, consisting of a sign bit and 3 significand bits, would represent plus and minus one as:

$$\begin{matrix}+ 1 = 0001 \\ - 1 = 1001\end{matrix}$$

In two's complement representation, an n-bit integer, i, is represented by the low order n bits of the binary n+1-bit value 2n+i, so a 4-bit two's complement integer would represent plus and minus one as:

$$\begin{matrix}+ 1 = 0001 \\ - 1 = 1111\end{matrix}$$

The two's complement format is practically universal for signed integers because it simplifies computer arithmetic.

A fixed-point number looks exactly like an integer, but actually represents a value that has a certain number of fractional bits. Sensor data is often in fixed-point format, and there is a great deal of fixed-point software that was written before the widespread adoption of FP. Fixed-point numbers are quite tedious to work with because a programmer has to keep track of the “binary point”, i.e. the separator between the integer and fractional parts of the number, and also has to constantly shift the number to keep the bits in the correct place. FP numbers don't have this difficulty, so it is desirable to be able to convert between fixed-point numbers and FP numbers. Being able to do conversions also means that we can still use fixed-point software and data, but we are not limited to fixed-point when writing new software.

### Rounding FP Numbers

Most FP operations are required by the IEEE-754 standard to be computed as if the operation were done with unbounded range and precision, and then rounded to fit into an FP number. If the computation exactly matches an FP number, then that value is always returned, but usually the computation results in a value that lies between two consecutive floating-point numbers. Rounding is the process of picking which of the two consecutive numbers should be returned.

There are a number of ways of rounding, called rounding modes; six of these are shown in Table 3, however it will be appreciated that processing units, such as the processor 700 described below may be capable of performing a different operation:

TABLE 3

| | Mode | Definition |
|---|---|---|
| RNE | round to nearest, | pick the closest value, or if both |
| | ties to even | values are equally close then pick the |
| | | even value |
| RNA | round to nearest, | pick the closest value, or if both |
| | ties to away | values are equally close then pick the |
| | | value furthest away from zero |
| RZ | round to zero | pick the value closest to zero |
| RP | round to plus infinity | pick the value closest to plus |
| | | infinity |
| RM | round to minus infinity | pick the value closest to negative |
| | | infinity |

The definition doesn't tell us how to round in any practical way. One common implementation is to do the operation, look at the truncated value (i.e. the value that fits into the FP format) as well as all of the remaining bits, and then adjust the truncated value if certain conditions hold. These computations are all based on:
L—(least) the least significant bit of the truncated value
G—(guard) the next most significant bit (i.e. the first bit not included in the truncation)
S—(sticky) the logical OR of all remaining bits that are not part of the truncation

Given these three values and the truncated value, we can always compute the correctly rounded value according to Table 4:

TABLE 4

| Mode | Change to truncated value |
|---|---|
| RNE | increment if (L&G) \| (G&S) |
| RNA | increment if G |
| RZ | none |
| RP | increment if positive & (G \| S) |
| RM | increment if negative & (G \| S) |
| RX | set L if (G \| S) |

For example, consider multiplying two 4-bit significands, and then rounding to a 4-bit significand.

$$sig 1 = 1011 \qquad ( decimal 11 )$$

$$sig 2 = 0111 \qquad ( decimal 7 )$$

multiplying yields

$$s i g 1 \times s i g 2 = 1001 \_ 101 \qquad ( decimal 77 )$$

### L Gss

The least significant bit of the truncated 4-bit result is labeled L, the next bit G, and S is the logical OR of the remaining bits labeled s (i.e. S=0|1=1). To round, we adjust our 4-bit result (1001) according to the rounding mode and the computation in the table above. So, for instance in RNA rounding, G is set so we return 1001+1=1010. For RX rounding G|S is true, so we set L to 1 (it's already 1, so in this case nothing changes) and return 1001.

### Rounding Integer and Fixed-Point Numbers

If we convert an FP number to integer or fixed-point we also have to round. The concept is basically the same as FP rounding. An FP number that happens to be an integer always rounds to that integer. All other FP numbers lie between two consecutive integers, and rounding dictates which integer is returned. Unfortunately, the rounding logic for integers is somewhat harder because of the differences between two's complement and sign-magnitude form. Incrementing a sign-magnitude number always increases the magnitude, so the incremented number is farther away from zero. The same thing happens for positive two's complement numbers, but negative two's complement numbers become closer to zero when incremented. This means that the rounding logic has to change based on whether the integer is positive or negative. It also means we have to be careful in picking the base value (the value which will be incremented or not). For positive integers, that value is just the truncated FP significand, so 1.37 will have a base value of 1, and a result of either 1 or 2. For negative integers, we again truncate the significand and take the one's complement of the result (one's complement is the original number with all bits inverted), −1.37 is truncated to 1 and then inverted, giving a base value of −2. Everything then works out since we want our result to be either −2 or (when incremented) −1.

To further complicate things, our method of conversion requires some computation to find L, G, and S for negative integers. Correct rounding would require us to complete the two's complement process (invert and add 1) and then compute L, G, and S, but adding that 1 is slow compared to just inverting. Ideally, we would like to compute the actual L, G, and S from the original shifted input (i.e., from the input before we've done anything about signs. So, the floating-point 1.37 or −1.37 would both be right shifted to the integer 1).

Let L0, G0, and S0 be the least significant bit (lsb), guard and sticky before inverting, and let Li, Gi, and Si be lsb, guard and sticky after inverting, and finally let L, G, and S be the lsb, guard and sticky after inverting and adding 1.

If S0 is zero, then the bits contributing to Si are all ones, and hence S (obtained by adding 1 to those Si bits) is also zero. If S0 is nonzero, then Si is not all ones, and hence S is nonzero. So, in all cases S0=S.

If G0 is zero, then Gi is 1, and G is also one except for the case when there is a carry-in from the S bits, which only happens when S0 is zero. If G0 is 1, then Gi is zero, and again G is also one except for the case where there is a carry-in from the S bits, which only happens when S0 is zero. So, G=G0\hat{ }S0.

By very similar logic, L=L0\hat{ }(G0|S0).

Now that we have L, G, and S for both negative and positive integers, we can come up with our rounding rules as shown in Table 5:

TABLE 5

| Mode | Change to a positive value | Change to a negative value |
|---|---|---|
| RNE | increment if (L&G) \| (G&S) | increment if (L&G) \| (G&S) |
| RNA | increment if G | increment if (G&S) |
| RZ | None | increment if (G \| S) |
| RP | increment if (G \| S) | increment if (G \| S) |
| RM | None | none |
| RX | set L if G \| S | set L if G \| S |

Fixed-point numbers round exactly the same way as integers. The rules for unsigned conversions (to integer or fixed-point) are the same as the rules for positive conversions.

### Injection Rounding

A faster way to do rounding is to inject a rounding constant as part of the significand addition that is part of almost every FP operation. To see how this works, consider adding numbers in dollars and cents and then rounding to dollars. If we add:

$$\underline{\begin{matrix}\$1 \text{.27} \\ + \$2 \text{.35}\end{matrix}} \\ \$3 \text{.62}$$

We see that the sum $3.62 is closer to $4 than to $3, so either of the round-to-nearest modes should return $4. If we represented the numbers in binary, we could achieve the same result using the L, G, S method from the last section. But suppose we just add fifty cents and then truncate the result?

$$\underline{\begin{matrix}1.27 \\ + 2.35 \\ + 0.5\end{matrix}} \\ 4.12 \qquad ( rounding injection )$$

If we just returned the dollar amount ($4) from our sum ($4.12), then we have correctly rounded using RNA rounding mode. If we added $0.99 instead of $0.50, then we would correctly round using RP rounding. RNE is slightly more complicated: we add $0.50, truncate, and then look at the remaining cents. If the cents remaining are nonzero, then the truncated result is correct. If there are zero cents remaining, then we were exactly in between two dollar amounts before the injection, so we pick the even dollar amount. For binary FP this amounts to setting the least significant bit of the dollar amount to zero.

Adding three numbers is only slightly slower than adding two numbers, so we get the rounded result much more quickly by using injection rounding than if we added two significands, examined L, G, and S, and then incremented our result according to the rounding mode.

### Implementing Injection Rounding

For FP, the rounding injection is one of three different values, values which depend on the rounding mode and (sometimes) the sign of the result.

Both RNA and RNE require us to inject a 1 at the G position (this is like adding $0.50 in our dollars and cents example).

RP and RM rounding depends on the sign as well as the mode. RP rounds positive results up (increases the magnitude of the significand towards positive infinity) but truncates negative results (picking the significand that is closer to positive infinity). Similarly, RM rounds negative results up (increasing the magnitude of the significand toward negative infinity) but truncates positive results (picking the significand that is closer to negative infinity). Thus, we split RM and RP into two cases: round up (RU) when the sign matches the rounding direction, and truncation (RZ) when the sign differs from the rounding injection. For RU cases we inject a 1 at the G-bit location and at every location that contributes logically to S (this is like adding $0.99 in our dollars and cents example).

For RZ and RX modes, and for RP and RM modes that reduce to RZ mode, we inject zeros.

For most of the rounding modes, adding the rounding injection and then truncating gives the correctly rounded result. The two exceptions are RNE and RX, which require us to examine G and S after the addition. For RNE, we set L to 0 if G and S are both zero. For RX we set L to 1 if G or S are nonzero.

### FP Number are not Real Numbers

It's tempting to think of FP numbers as being just like real numbers, but they are fundamentally different, even for the most basic properties:
1. They are not associative. For example, in SP we can add 3 numbers and return 1 million or zero, perhaps not what people think of as a rounding error:

$$\begin{matrix}( 245 + - 245 ) + 220 = 220 \\ 245 + ( - 245 + 220 ) = 0\end{matrix}$$

2. They don't obey the distributive laws. Again, in SP:

$$\begin{matrix}3 , 000 , 001 * ( 4.00001 + 5.00001 ) = 0 \times 4 bcdfe 83 \\ ( 3 , 000 , 001 * 4.00001 ) + ( 3 , 000 , 001 * 5.00001 ) = 0 \times 4 bcdfe 82\end{matrix}$$

and things get even worse in the presence of overflow:

$$\begin{matrix}250 * ( 278 - 277 ) = 2127 \\ ( 250 * 278 ) - ( 250 * 277 ) = infinity\end{matrix}$$

3. In some implementations, they aren't even commutative unless we are in default NaN mode (a mode that converts all NaNs to a single NaN), because in general nanA+nanB!=nanB+nanA. Numeric adds and multiplies are commutative.
4. Because of IEEE NaN rules, there are no multiplicative or additive identities. One and zero work as identities for numeric values.

One useful way to think of FP numbers is to consider them to be very long fixed-point numbers in which at most a few (53 for DP) consecutive bits can be nonzero. For example, non-infinite DP numbers can have the first bit of the significand in any of 2046 places, and that first bit is followed by 52 other significand bits, and there is a sign bit, so any finite DP number can be represented as a 2046+52+1=2099-bit fixed point number. Examined this way it becomes very obvious that adding two FP numbers does not, in general, result in another FP number: the result of the addition has to be rounded so that it becomes an FP number.

### Tensor Processing

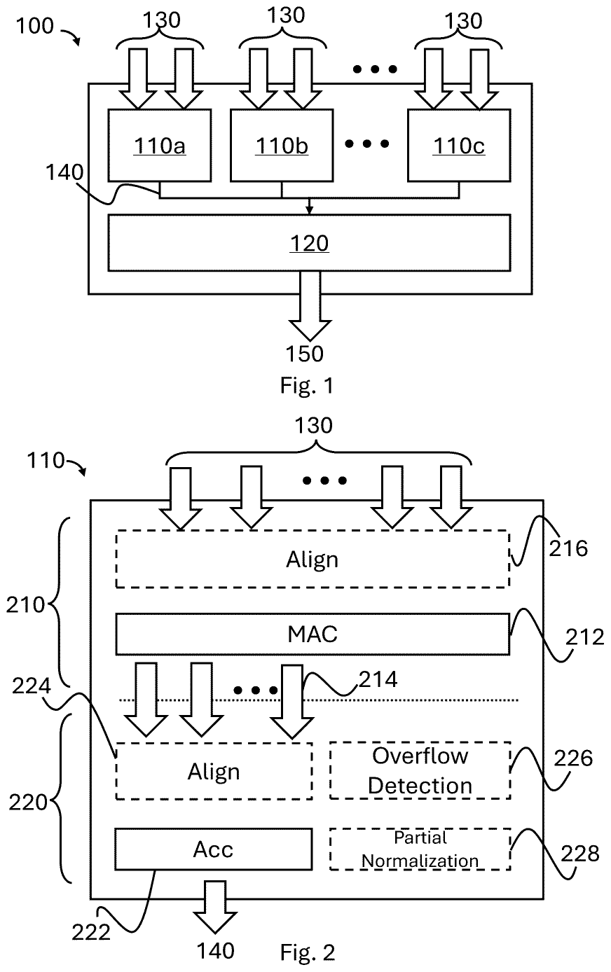

FIG. 1 illustrates a schematic diagram of tensor processing circuitry 100 for processing input data, such as tensor for one or more operations. The tensor processing circuitry 100 comprises a plurality of dot-product units 110a, 110b, 110c. The dot-product units 110 will be described in further detail below with reference to FIG. 2. It will be appreciated that whilst three dot-product units 110 are shown in FIG. 1, that there may be more or less than three. In some examples, the number of dot-product units 110 in the tensor processing circuitry 100 is based on other hardware of the tensor processing circuitry 100, such as the normalization unit 120. In such examples, the number of dot-product units 110 may be based on limitations and/or the ability of the normalization circuitry 120 to perform normalization such as the number of dot-product units 110 correlating to the number of cycles the normalization circuitry 120 performs the normalization over. The tensor processing circuitry 100 may be configured for performing matrix multiplication and/or accumulation and may form part of a larger machine learning accelerator, as described below with reference to FIG. 4.

Each dot-product unit 110 receives a plurality of inputs 130. The inputs may be weight inputs and activation inputs, and whilst only two inputs 130 are shown in FIG. 1, it will be appreciated that any number of inputs 130 may be received. For example, each dot-product unit 110 may receive eight weight inputs and eight activation inputs with their own format. The format may comprise a:
1-bit sign value;
8-bit exponent; and
8-bit mantissa,
where the leading unit before the binary point is encoded in the mantissa. It will be appreciated that other numbers of weight and activation inputs may be received.

Each dot-product unit 110 may consume inputs 130 each clock cycle, such that the dot-product unit is configured to perform the operations on the inputs each clock cycle. In some examples, the number of inputs 130 received each clock cycle may correlate with the number of operations performed by the dot-product units 110 each cycle. For example, where 8 pairs of inputs 130 are received, the dot-product unit 110 will perform 8 operations each cycle.

The dot-product units 110 may be configured to perform a number of operations, however, in examples, described herein, the dot-product units 110 are configured to perform multiply-accumulate operations as will be described in further detail below. The outputs 140 of the multiply-accumulate operations may in general be in an unnormalized format, such that multiple outputs of the multiply-accumulate operations are accumulated to output an unnormalized result. This unnormalized result may then be output to normalization circuitry 120 for normalization, before output to an accumulator buffer, such as accumulator buffer 736 of the processor 700 described below with reference to FIG. 4.

By splitting the normalization operations away from the individual dot-product units 110, unnormalized results from the plurality of dot-product units 110 may be normalized. This allows the hardware required for the normalization of the outputs of a multiply-accumulate (‘MAC’) operation to be amortized across multiple dot-product units, along with reducing the processing costs associated with such normalization, by using an unnormalized accumulator and storing the unnormalized outputs in an unnormalized format. Once normalized, the normalization circuitry 120 outputs the normalized result for further processing, such as by storing the normalized result in an accumulator buffer.

The normalization circuitry 120 may comprise an accumulator (not shown) for normalizing and accumulating the unnormalized results and storage (not shown) for storing accumulated normalized results output from the accumulator.

FIG. 2 illustrates a schematic diagram of a dot-product unit 110 for use with the tensor processing circuitry 110 shown in FIG. 1. As described above, the tensor processing circuitry 100 may comprise a plurality of dot-product units 110, arranged to each receive a plurality of inputs. The dot-product unit 110 comprises at least two stages, a first stage 210 and a second stage 220.

The first stage 210 comprises multiply-accumulate (MAC) circuitry 212 to perform at least a MAC operation. The output(s) 214 of the MAC circuitry 212 (first stage accumulated value(s)) are in an unnormalized floating-point format to minimize additional processing at this stage since normalization operations are expensive to implement in terms of circuit area. Additional considerations to prevent overflow etc. are therefore required as a result of keeping any outputs in a unnormalized floating-point format. To maintain the outputs 214 in a unnormalized floating-point format the number of integer bits needs to be tracked, as will be described in further detail below.

In some examples, the first stage 210 comprises alignment circuitry 216. While illustrated in FIG. 2 as separate, in practice the alignment circuitry 216 may be combined with the MAC circuitry 212. The alignment circuitry 216 compares the sum of the exponents of the (pairs of) input values 130 to determine a maximum exponent. The mantissa of each (pair of) input values 130 is multiplied together. A difference between the maximum exponent and each individual exponent of the input values 130 is representative of the amount of shift needing to be applied to the product of the mantissa of the input values 130 to align values before accumulation by the MAC circuitry 212. No normalization is performed at this stage to regularize accumulated products.

The unnormalized floating-point outputs 214 of the MAC circuitry 212 are fed into a second stage 220 of the dot-product unit 110 which comprises at least an accumulator 222. The accumulator 222 performs an accumulation operation on each of the received unnormalized floating-point outputs 216 from the first stage circuitry 210 to generate an unnormalized result 140. The unnormalized result 140 is then output to the normalization circuitry 120 and further processed, alongside the unnormalized results 140 from several other dot-product units 110 of the tensor processing circuitry as described above in relation to FIG. 1.

As with the first stage 210, the second stage 220 may also comprise alignment circuitry 224. The unnormalized floating point outputs 214 are output in different cycles from the accumulator in the MAC circuitry 212. Each unnormalized floating point output 214 has its exponent compared with the exponent of the value currently stored in an accumulator 222 of the second stage 220. The one of the unnormalized floating point output 214 and the exponent value currently stored in the accumulator that has the smaller exponent has its mantissa and exponent adjusted in accordance with the comparison before being added to the other value.

In some examples, it is desirable to determine whether an overflow of the accumulator 222 will occur. For example, when the dot-product unit 110 receives eight input pairs 130, as described above, the unnormalized floating-point output 214 of the MAC operation performed by the MAC circuitry 212 comprises six bits. These six bits, when subsequently added into the accumulator 222 with the current stored total can cause overflow. For example the accumulator 222 may support a maximum of 7 bits and the total may exceed 7 bits. Determining whether an overflow will occur as a result of an accumulate operation performed by the accumulator 222, and preventing such overflow is important and results in further efficiencies, especially given that overflow can occur following the performance of very few operations. Detecting, and then preventing such overflow in subsequent cycles can be achieved with minimal additional hardware.

Overflow detection circuitry 226 in the second stage 220 of the dot-product unit 110 detects whether an overflow of the unnormalized mantissa is likely to result from an accumulate operation. It is noted that the value in the accumulator after the accumulate operation may still be within a range of numbers that can be stored by the accumulator, but that an overflow of the mantissa may occur due to a lack of normalization. Whilst there are numerous ways that overflow can be detected, one way is to perform an XOR operation on the two most significant bits of a mantissa of the unnormalized floating-point result currently stored in the accumulator 222.

The overflow detection circuitry 226 may comprise the necessary hardware to perform such an XOR operation on the two most significant bits of the stored unnormalized floating-point result. The result of the XOR operation is either a 1 or a zero. In one implementation, the overflow detection circuitry 226 uses 2's complement format. For 2's complement, 1000 . . . is the largest possible negative number, and 011111 . . . is the largest possible positive number. Accordingly, 10 or 01 in the most significant bits of a value stored in the accumulator 222 may indicate a potential overflow. In this example, if the result of the XOR operation is one, then this is indicative that the next multiply-accumulate operation to be performed by the MAC circuitry 212 may result in an overflow of the accumulator 222. Conversely, if the result of the XOR operation is a zero then the next multiply-accumulate operation to be performed by the MAC circuitry 212 will not result in an overflow of the accumulator 222.

If the overflow detection circuitry 226 indicates that an overflow may occur (e.g., the output of the XOR operation is a one, then further processing is required to prevent the overflow before the accumulator 222 performs its accumulation operation. As such, the second stage 220 of the dot-product unit 110 may also comprise partial normalization circuitry 228. The partial normalization circuitry 228 is configured to perform partial normalization operations on the output of the accumulate operation performed by the accumulator 222 when overflow is detected by the overflow detection circuitry 226. This partial normalization may be significantly less complex and computationally expensive operation than the full normalization undertaken by the normalization circuitry 120 of the tensor processing circuitry 100 described above with reference to FIG. 1.

There are a number of methods for partially normalizing an output stored in the accumulator 222, one such method is to implement a right-shift-by-one of the mantissa. In cases where the mantissa is right-shifted-by-one, the exponent of the output stored in the accumulator 222 may also be increased by one. This may be achieved using shifting circuitry and is an efficient and computationally inexpensive method of preventing the overflow detected by the overflow detection circuitry 226.

Following the accumulation (whether overflow is detected or not), the output 140, in a unnormalized floating-point format, of the accumulator is provide to the normalization circuitry 120 for normalization alongside the outputs 140 from other dot-product units 110.

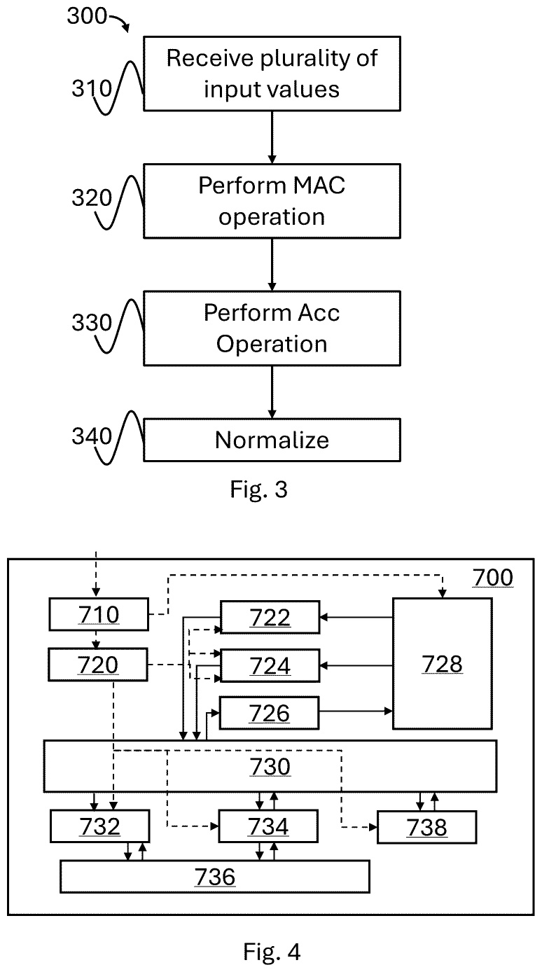

FIG. 3 is a flowchart showing a method 300 according to the present disclosure, the method 300 is performed by tensor processing circuitry, such as tensor processing circuitry 100 described above with reference to FIG. 1, and comprising dot-product units 110 such as those described with reference to FIG. 2.

At step 310, a plurality of input values is received by a first stage 210 of a dot-product unit 110 of the tensor processing circuitry 100 configured to perform the method 300. The plurality of input values, as described above, may comprise eight weight inputs and eight activation inputs with their own format. In other examples, a matrix multiplication may be performed. The format may comprise a:
1-bit sign value;
8-bit exponent; and
8-bit mantissa,
where the leading unit before the binary point is encoded in the mantissa. It will be appreciated that other numbers of weight and activation inputs could be received by the first stage.

Following receipt of the input values at step 320 at least a multiply-accumulate operation is performed on pairs of the input values at the first stage of the dot-product unit. The multiply-accumulate operations produce an output in a unnormalized floating-point format. In some examples, other operations may be performed prior to or during the multiply-accumulate operation, such as an alignment as described above.

The unnormalized floating-point outputs of the multiply-accumulate operation are then accumulated, at step 330 by an accumulator (such as accumulator 222) in a second stage 220 of the dot-product unit. The accumulation operation performed by the accumulator generates a unnormalized result. As described above, the use of unnormalized floating-point means that in some examples the accumulation operation will result in an overflow of the mantissa of the accumulated value stored in the accumulator. Therefore, in such examples, further operations may be undertaken at the second stage 220 of the dot-product unit. As described above, these further operations may include a second alignment step, an overflow detection step, and a partial normalization step.

Following the accumulate operation at step 330, the method proceeds to step 340, where the output of the accumulation operation from the dot-product unit 110 is normalized by normalization circuitry, such as normalization circuitry 120 described above. The normalization step 340 may comprise receiving the unnormalized outputs from a plurality of dot-product units 110a, 110b, 110c of the tensor processing circuitry 100 and performing the normalization across all those outputs.

FIG. 4 is a schematic diagram of a processor 700, such as a neural engine, which may comprise the components, such as the tensor processing circuitry 100 described above with reference to FIG. 1. The processor 700 includes a command and control module 710. The command and control module 710 receives tasks from a command processing unit (not shown), and also acts as an interface to storage external to the processor 700 (such as a local cache and/or a L2 cache) which is arranged to store data to be processed by the processor 700 such as data representing a tensor, or data representing a stripe of a tensor. In the context of the present disclosure, a stripe is a subset of a tensor in which each dimension of the stripe covers a subset of the full range of the corresponding dimension in the tensor. The external storage may additionally store other data to configure the processor 700 to perform particular processing and/or data to be used by the processor 700 to implement the processing such as neural network weights.

The command and control module 710 interfaces to a handling unit 720, which is for example a traversal synchronization unit (TSU). In this example, each task corresponds to a stripe of a tensor which is to be operated upon in accordance with a sequence of operations according to at least a portion (e.g. a sub-graph) of the acyclic graph representation of the neural network. The tensor for example represents a feature map for processing using the neural network. A neural network typically includes a sequence of layers of processing, with an output from each layer being used as an input to the next layer. Each layer for example processes an input feature map by operating upon the input feature map to generate an output feature map, which is used as the input feature map for the next layer. The term “feature map” is used generically herein to refer to either an input feature map or an output feature map. The processing performed by a given layer may be taken to correspond to an operation.

In this example, the handling unit 720 splits data representing a stripe of a feature map into a plurality of blocks of data, each of which represents a respective part of the feature map. The handling unit 720 also obtains, from storage external to the processor 700 such as the L2 cache, task data defining operations selected from an operation set comprising a plurality of operations. In this example, the operations are structured as a chain of operations representing a sequence of layers of the neural network. A block of data is allocated as an input to one of the operations by the handling unit 720.

The handling unit 720 coordinates the interaction of internal components of the processor 700, which include a weight fetch unit 722, an input reader 724, an output writer 726, a direct memory access (DMA) unit 728, a dot-product unit (DPU) array 730 (which may comprise a plurality of the dot-product units 110 described above with reference to FIG. 2 and may be part of the larger tensor processing circuitry 100 described above with reference to FIG. 1), a vector engine 732, a transform unit 734, an accumulator buffer 736, and a storage 738, for processing of blocks of data. The data dependencies across the functional units are tracked by the handling unit 720. Processing is initiated by the handling unit 720 in a functional unit if all input blocks are available and space is available in the storage 738 of the processor 700. The storage 738 may be considered to be a shared buffer, in that various functional units of the processor 700 share access to the storage 738.

In the context of a directed acyclic graph representing the operations to be performed, each of the internal components that operate upon data can be considered to be one of two types of components. The first type of component is an execution unit (and is identified within the processor 700 as such) that maps to a section that performs a specific instance of an operation within the acyclic graph. For example, the weight fetch unit 722, input reader 724, output writer 726, dot product unit array 730, vector engine 732, and transform unit 734 each are configured to perform one or more pre-determined and fixed operations upon data that it receives. Each of these sections can be uniquely identified with an identifier and each execution unit can also be uniquely identified.

Similarly, all physical storage elements within the neural engine (and in some instances portions of those physical storage elements) can be considered to be uniquely identified within the neural engine. The connections between sections in the acyclic graph representing the neural network are also referred to as pipes within the context of the acyclic graph. These pipes can also be mapped to the uniquely identified physical storage elements in the neural engine. For example, the accumulator buffer 736 and storage 738 (and portions thereof) can each be regarded as a storage element that can act to store data for a pipe within the acyclic graph. The pipes act as connections between the sections (as executed by execution units) to enable a sequence of operations as defined in the acyclic graph to be chained together within the processor 700. Put another way, the logical dataflow of the acyclic graph can be mapped to the physical arrangement of execution units and storage elements within the processor 700. Under the control of the handling unit 720, execution can be scheduled on the execution units and data can be passed between the execution units via the storage elements in accordance with the mapping, such that the chained operations of a graph can be executed without needing to write data memory external to the processor 700 between executions. The handling unit 720 is configured to control and dispatch work representing performing an operation of the graph on at least a portion of the data provided by a pipe.

The weight fetch unit 722 fetches weights associated with the neural network from external storage and stores the weights in the storage 738. The input reader 724 reads data to be processed by the processor 700 from external storage, such as a block of data representing part of a tensor. The output writer 726 writes data obtained after processing by the processor 700 to external storage. The weight fetch unit 722, input reader 724 and output writer 726 interface with the external storage (which is for example the local cache, which may be a L1 cache such as a load/store cache) via the DMA unit 728.

Data is processed by the DPU array 730, vector engine 732 and transform unit 734 to generate output data corresponding to an operation in the acyclic graph. The result of each operation is stored in a specific pipe within the processor 700. The DPU array 730 is arranged to perform one or more operations associated with a dot product operation between two operands, such as between an array of weights and a corresponding block of data (e.g. representing part of a tensor). The vector engine 732 is arranged to perform elementwise operations, for example to apply scale parameters to scale an output of a dot product calculated by the DPU array 730. Data generated during the course of the processing performed by the DPU array 730 (or larger tensor processing circuitry 100) and the vector engine 732 may be transmitted for a temporary stage in the accumulator buffer 736, at which acts as a pipe between the previous operation and the subsequent operation, from where it may be retrieved by either the DPU array 730 or the vector engine 732 (or another different execution unit) for further processing as desired.

The transform unit 734 is arranged to perform in-block transforms such as dimension broadcasts or axis swaps. The transform unit 734 obtains data from a pipe, such as storage 738 (e.g. after processing by the DPU array 730 and/or vector engine 732) and writes transformed data back to the storage 738.

To make efficient use of the storage 738 available within the processor 700, the handling unit 720 determines an available portion of the storage 738, which is available during the execution of part of a first task (e.g. during processing of a block of data associated with the first task by the DPU array 730, vector engine 732 and/or transform unit 734). The handling unit 720 determines a mapping between at least one logical address associated with data generated during the execution of a second task (e.g. by processing of a block of data associated with the second task by the DPU array 730, vector engine 732 and/or transform unit 734) and at least one physical address of the storage 738 corresponding to the available portion. The logical address is for example a global address in a global coordinate system. Hence, by altering the physical address corresponding to a given logical address, the handling unit 720 can effectively control usage of the storage 738 without requiring a change in software defining the operation to be performed, as the same logical address can still be used to refer to a given element of the tensor to be processed. The handling unit 720 identifies the at least one physical address corresponding to the at least one logical address, based on the mapping, so that data associated with the logical address is stored in the available portion. The handling unit 720 can perform the mapping process according to any of the examples herein.

It will be appreciated that in a graph of operations there does not need to be only a single instance of a particular type of operation. For example, multiple instances of a convolution operation could be present in a graph of operations. In the above example hardware arrangement only a single convolution engine may be present. Therefore, it will be appreciated that there does not need to be a direct 1:1 mapping between operations in the graph (sections) and execution units, and similarly no direct 1:1 mapping between pipes and storage elements. In particular, a single execution unit may be configured at different instances in time to execute different instances of a convolution operation (e.g. first and second sections). Similarly, the input reader may be required to read data as part of different sections in the graph. The same can be said for storage elements and pipes.

All storage in the processor 700 may be mapped to corresponding pipes, including look-up tables, accumulators, etc. Some storage may be relatively fixed purpose, for example, if the hardware were limited to one convolution operation per graph the accumulator buffer might also be limited to being mapped to one pipe, and scale/bias/shift buffer might be limited to being mapped to one pipe; however, both would likely be double buffered. If the neural engine supports 2 look-up tables (LUTs), then a maximum of 2 pipes could be used to target the LUTs to avoid needing to thrash the LUT storage; LUT pipes might then be single buffered. All other pipes could be mapped to a common Shared Buffer (or portions thereof) with fewer restrictions. Width and height of pipe can also be programmable, resulting a highly configurable mapping between pipes and storage elements within the processor 700.

Ordering of execution of the sections is implied by dependencies on inputs. A memory load operation generally has no data dependencies, so is implicitly early in the graph. The consumer of the pipe the memory read produces is implicitly after the memory read. A memory store operation is near the end of the graph, as it produces no pipes for other operations to consume. The sequence of execution of a chain of operations is therefore handled by the handling unit 720 as will be explained in more detail later.

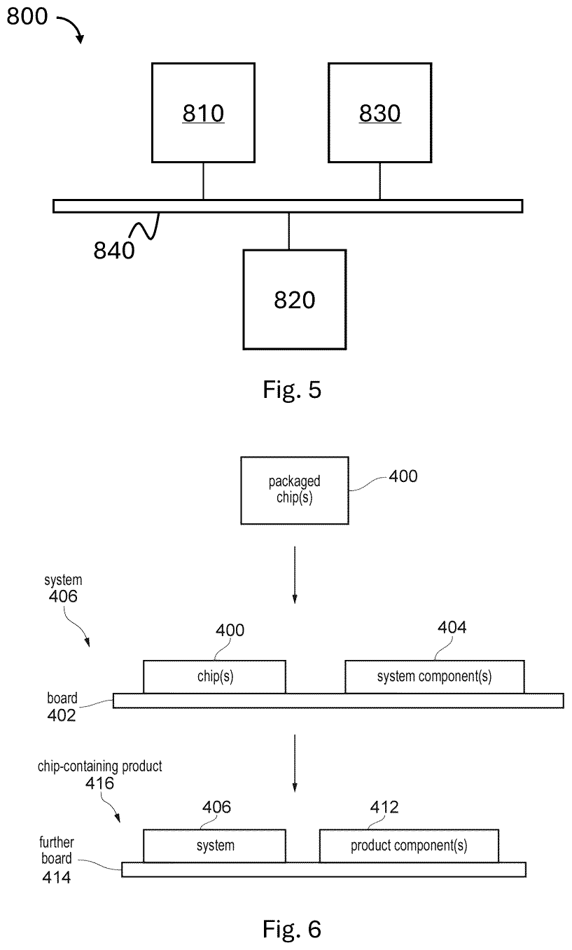

FIG. 5 shows schematically a system 800 for allocating handling data, and in some examples generating a plurality of blocks of input data for processing.

The system 800 comprises host processor 810 such as a central processing unit, or any other type of general processing unit. The host processor 810 issues a command stream comprising a plurality of commands, each having a plurality of tasks associated therewith.

The system 800 also comprises a processor 830, such as processor 700 described above with reference to FIG. 4 and may comprise at least some of the components of and/or be configured to perform the methods described above. The processor 830 comprises at least a plurality of compute units and a command processing unit. Each compute unit may comprise a plurality of processing modules each configured to perform at least one type of operation. The system 800 may also include at least one further processor (not shown), which may be the same as the processor 830. The processor 830, and the host processor 810 may be combined as a System on Chip (SoC) or onto multiple SoCs to form one or more application processors.

The system 800 also comprises memory 820 for storing data generated by the tasks externally from the processor 830, such that other tasks operating on other processors may readily access the data. However, it will be appreciated that the external memory usage will be used sparingly, due to the allocation of tasks as described above, such that tasks requiring the use of data generated by other tasks, or requiring the same data as other tasks, will be allocated to the same compute unit of a processor 830 so as to maximize the usage of the local cache.

In some examples, the system 800 may comprise a memory controller (not shown), which may be a dynamic memory controller (DMC). The memory controller is coupled to the memory 820. The memory controller is configured to manage the flow of data going to and from the memory. The memory may comprise a main memory, otherwise referred to as a ‘primary memory’. The memory may be an external memory, in that the memory is external to the system 800. For example, the memory 820 may comprise ‘off-chip’ memory. The memory may have a greater storage capacity than local caches of the processor 830 and/or the host processor 810. In some examples, the memory 820 is comprised in the system 800. For example, the memory 820 may comprise ‘on-chip’ memory. The memory 820 may, for example, comprise a magnetic or optical disk and disk drive or a solid-state drive (SSD). In some examples, the memory 820 comprises a synchronous dynamic random-access memory (SDRAM). For example, the memory 820 may comprise a double data rate synchronous dynamic random-access memory (DDR-SDRAM).

One or more of the host processor 810, the processor 830, and the memory 820 may be interconnected using a system bus 840. This allows data to be transferred between the various components. The system bus 840 may be or include any suitable interface or bus. For example, an ARM® Advanced Microcontroller Bus Architecture (AMBAR) interface, such as the Advanced extensible Interface (AXI), may be used.

As shown in FIG. 6, one or more packaged chips 400, with the processing unit described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the circuitry described above and/or connectors, such as lands, balls or pins, for connecting the semiconductor devices to an external environment. Where more than one chip 400 is provided, these could be provided as separate integrated circuits (provided as separate packages) or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, System Verilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and System Verilog or other behavioral representations of the concepts that can be interpreted by a computer to enable simulation, functional and/or formal verification, and testing of the concepts.

Additionally, or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively, or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively, or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In the preceding description, for purposes of explanation, numerous specific details of certain examples are set forth. Reference in the specification to “an example” or similar language means that a particular feature, structure, or characteristic described in connection with the example is included in at least that one example, but not necessarily in other examples.

The above examples are to be understood as illustrative examples of the disclosure. Further examples of the disclosure are envisaged. It is to be understood that any feature described in relation to any one example may be used alone, or in combination with other features described, and may also be used in combination with one or more features of any other of the example, or any combination of any other of the examples. Furthermore, equivalents and modifications not described above may also be employed without departing from the scope of the disclosure, which is defined in the accompanying claims.

What is claimed is:

1. A tensor processing circuitry comprising:
a plurality of dot product units; and
normalization circuitry,
wherein each dot product unit comprises first-stage circuitry and second-stage circuitry, the first-stage circuitry configured to:
receive a plurality of input values; and
perform at least a multiply-accumulate operation on pairs of the plurality of input values, the multiply-accumulate operation producing an output value in a unnormalized floating-point format; and
the second stage circuitry configured to:
receive a plurality of the unnormalized floating-point output values from the first stage circuitry;
perform, by an accumulator of the second stage circuitry, an accumulate operation on each of the received unnormalized floating-point output values to generate an unnormalized result; and
output the unnormalized result of the accumulate operation to the normalization circuitry; and
wherein the normalization circuitry is configured to receive unnormalized results from the plurality of dot product units and normalize the unnormalized results.

2. The tensor processing circuitry according to claim 1, wherein the second-stage circuitry further comprises overflow detection circuitry for detecting whether the accumulate operation will result in an overflow of the accumulator of the second stage circuitry.

3. The tensor processing circuitry according to claim 2, wherein the overflow detection circuitry comprises circuitry to perform at least an XOR operation on the two most significant bits of a mantissa of a currently stored unnormalized result in the accumulator of the second stage circuitry.

4. The tensor processing circuitry according to claim 3, wherein the XOR operation indicates:
that the multiply-accumulate operation may result in an overflow when the result of the XOR operation is 1; and
that the multiply-accumulate operation will not result in an overflow when the result of the XOR operation is 0.

5. The tensor processing circuitry according to claim 2, wherein the second stage circuitry comprises partial normalization circuitry for partially normalizing the output of the accumulate operation when the overflow detection circuitry detects an overflow.

6. The tensor processing circuitry according to claim 5, wherein the partial normalization circuitry comprises shifting circuitry for right-shifting the currently stored unnormalized result by one.

7. The tensor processing circuitry according to claim 1, wherein the plurality of input values each comprise a sign, an 8-bit exponent, and an 8-bit mantissa.

8. The tensor processing circuitry according to claim 1, comprising a given number of dot product units, wherein the normalization circuitry is configured to normalize the unnormalized results from the given number of dot product units every given number of cycles.

9. The tensor processing circuitry according to claim 1, comprising receiving a predetermined number of pairs of input values each cycle, and performing the predetermined number of multiply-accumulate operations at each dot product unit each cycle.

10. The tensor processing circuitry according to claim 1, wherein the normalization circuitry comprises a second accumulator for normalizing and accumulating the unnormalized results and a storage for storing accumulated normalized results output from the second accumulator.

11. The tensor processing circuitry according to claim 1, wherein the at least one dot product unit and normalization circuitry are configured for performing matrix multiplication and/or accumulation.

12. The tensor processing circuitry according to claim 1, wherein the tensor processing circuitry is part of a machine learning accelerator.

13. A method performed by tensor processing circuitry comprising:
at each of a plurality of dot product units of the tensor processing circuitry:
receiving, at a first stage of each dot product unit, a plurality of input values;
performing, at a first stage of each dot product unit, at least a multiply-accumulate operation on pairs of the plurality of input values, the multiply-accumulate operation producing an output value in a unnormalized floating-point format; and
performing, at a second stage of each dot product unit, an accumulate operation on each of the unnormalized floating point output values to generate a unnormalized result; and
normalizing, at a normalization circuitry, at least the unnormalized results from the plurality of dot product units.

14. A processing unit for handling data, the processor comprising tensor processing circuitry according to claim 1, wherein the processor is configured to perform one or more convolution and/or matrix multiply operation using the tensor processing circuitry.

15. A system comprising:
the tensor processing circuitry according to claim 1, implemented in at least one packaged chip;
at least one system component; and
a board,
wherein the at least one packaged chip and the at least one system component are assembled on the board.

16. A chip-containing product comprising the system of claim 14, wherein the system is assembled on a further board with at least one other product component.

17. A non-transitory computer-readable storage medium having stored thereon, computer-readable code for fabrication of the tensor processing circuitry according to claim 1.
